(19) United States
(12) Patent Application Publication
(10) Pub. No.: US 2018/0221976 A1
(43) Pub. Date: Aug. 9, 2018

(54) GEAR CUTTER MACHINING APPARATUS, GEAR CUTTER MACHINING METHOD, TOOL PROFILE SIMULATION APPARATUS, AND TOOL PROFILE SIMULATION METHOD

(71) Applicant: JTEKT CORPORATION, Osaka-shi (JP)

(72) Inventors: Katsuhito YOSHINAGA, Kashihara-shi (JP); Hideki SHIBATA, Kariya-shi (JP)

(73) Assignee: JTEKT CORPORATION, Osaka-shi (JP)

(21) Appl. No.: 15/880,965

(22) Filed: Jan. 26, 2018

(30) Foreign Application Priority Data
Feb. 3, 2017 (JP) 2017-018876

(51) Int. Cl. B23F 5/16

(52) U.S. Cl. CPC B23F 5/163

(57) ABSTRACT

A controller of a gear cutter machining apparatus includes a rotation control unit and a movement control unit. The rotation control unit rotates a gear cutter about a central axis of the gear cutter, and rotates a grinding wheel about a central axis of the grinding wheel. The movement control unit gradually changes a crossed axes angle when relatively moving the grinding wheel in a direction of the central axis of the gear cutter, and moves the grinding wheel in a translating direction that is a rotational tangent direction of the gear cutter.

### INCORPORATION BY REFERENCE

The disclosure of Japanese Patent Application No. 2017-018876 filed on Feb. 3, 2017 including the specification, drawings and abstract, is incorporated herein by reference in its entirety.

### BACKGROUND OF THE INVENTION

### 1. Field of the Invention

The present invention relates to a gear cutter machining apparatus, a gear cutter machining method, a tool profile simulation apparatus, and a tool profile simulation method.

### 2. Description of the Related Art

A gear cutter for cutting a gear is formed into a profile based on the profile of the gear to be cut. When the edge top of the gear cutter is worn out, regrinding is performed. For example, Japanese Patent No. 4763611 (JP 4763611 B) describes an invention relating to an edge profile contour of a pinion type cutter. This invention relates to a method for determining a deviation of the edge profile contour from an ideal edge profile when the pinion type cutter is reground.

Japanese Patent No. 3080824 (JP 3080824 B) describes an invention relating to regrinding of a pinion type cutter as a gear cutter. In this invention, an approximate linear movement locus and an approximate arcuate movement locus are determined based on an ideal movement locus of a grinding wheel for grinding the pinion type cutter, that is, a movement locus for achieving an ideal tooth thickness of a gear cut after the regrinding. In this method, grinding is performed while correcting the movement locus of the grinding wheel in an edge thickness direction of the pinion type cutter in accordance with a deviation of the pinion type cutter in a radial direction based on both the movement loci.

In recent years, gear machining capable of achieving high-speed cutting is desired in view of cost, and skiving described in Japanese Patent Application Publication No. 2012-171020 (JP 2012-171020 A) is known. The skiving is machining to be performed by relatively moving a gear cutter along the central axis of an object to be cut while synchronously rotating the object to be cut and the gear cutter about the respective central axes in a state in which the central axis of the object to be cut and the central axis of the gear cutter are inclined (state in which a crossed axes angle is formed in the gear machining).

Japanese Patent Application Publication No. 2014-237185 (JP 2014-237185 A) describes an invention relating to a gear machining simulation apparatus. This simulation apparatus defines a plurality of definition points along a boundary line between the end face and the side face of a tool edge to grasp the magnitude of a cutting force applied to a certain portion of the tool edge. The result can be used for determining machining conditions such as a cutting amount and a feeding rate. Further, the simulation apparatus can grasp a worn-out portion of the tool edge, and therefore the life of the tool can be estimated.

When the skiving gear cutter (skiving cutter) is manufactured by a pinion type cutter machining method, the thickness of the tool edge (corresponding to the tooth thickness of the gear) decreases and the outside diameter of the tool also decreases due to the regrinding. Therefore, the gear machined by the reground skiving cutter has a tooth profile deviation and a tooth thickness deviation from an ideal gear. Those deviations tend to increase as the regrinding amount increases. Thus, the skiving cutter generally reaches the end of its life when the regrinding amount is about 2 to 5 mm (regrinding is performed about 10 times).

In the invention described in JP 4763611 B, there is no mention of the tooth profile deviation and the tooth thickness deviation of the gear along with the increase in the regrinding amount. In the invention described in JP 3080824 B, the increase in the tooth thickness deviation of the gear along with the increase in the regrinding amount can be suppressed, but the increase in the tooth profile deviation of the gear cannot be suppressed. At the site of mass production, the total cost of the skiving cutter is a key factor among others. Therefore, it is desired to provide a skiving cutter in which the regrinding amount can be secured as much as possible while suppressing the increase in the tooth profile deviation and the tooth thickness deviation of the gear along with the increase in the regrinding amount.

### SUMMARY OF THE INVENTION

It is one object of the present invention to provide a skiving gear cutter machining apparatus, a skiving gear cutter machining method, a tool profile simulation apparatus, and a tool profile simulation method, in which a large regrinding amount can be secured.

A gear cutter machining apparatus according to one aspect of the present invention includes a grinding wheel and a controller. The grinding wheel is formed into a disc profile. The controller is configured to control the grinding wheel to grind edge side faces of a gear cutter having a plurality of cutting teeth on its peripheral face in a state in which a central axis of the gear cutter and a central axis of the grinding wheel are inclined by a crossed axes angle from a state in which the central axis of the gear cutter and the central axis of the grinding wheel are orthogonal to each other.

The gear cutter is a tool to be used for skiving that is performed in a state in which the central axis of the gear cutter is inclined with respect to a central axis of a gear to be cut by the gear cutter.

The controller includes a rotation control unit and a movement control unit. The rotation control unit is configured to rotate the gear cutter about the central axis of the gear cutter, and to rotate the grinding wheel about the central axis of the grinding wheel. The movement control unit is configured to gradually change the crossed axes angle when relatively moving the grinding wheel in a direction of the central axis of the gear cutter, and to move the grinding wheel in a translating direction that is a rotational tangent direction of the gear cutter.

When the skiving gear cutter is manufactured by a pinion type cutter machining method, the thickness of the tool edge decreases and the outside diameter of the tool also decreases due to the regrinding. Therefore, the gear machined by the reground skiving gear cutter has a tooth profile deviation from an ideal gear. The tooth profile deviation tends to increase as the regrinding amount increases. The tooth profile deviation depends on the crossed axes angle formed between the central axis of the gear cutter and the central axis of the grinding wheel. By grinding the gear cutter while gradually changing the crossed axes angle in accordance with the tooth profile deviation, the increase in the tooth profile deviation can be suppressed. Thus, the gear cutter machining apparatus according to the present invention can machine a skiving gear cutter in which a large regrinding amount can be secured.

A gear cutter machining method according to another aspect of the present invention uses a grinding wheel formed into a disc profile, and causes the grinding wheel to grind edge side faces of a gear cutter having a plurality of cutting teeth on its peripheral face in a state in which a central axis of the gear cutter and a central axis of the grinding wheel are inclined by a crossed axes angle from a state in which the central axis of the gear cutter and the central axis of the grinding wheel are orthogonal to each other.

The gear cutter is a tool to be used for skiving that is performed in a state in which the central axis of the gear cutter is inclined with respect to a central axis of a gear to be cut by the gear cutter.

The gear cutter machining method includes a rotation control step and a movement control step. The rotation control step is a step of rotating the gear cutter about the central axis of the gear cutter, and rotating the grinding wheel about the central axis of the grinding wheel. The movement control step is a step of gradually changing the crossed axes angle when relatively moving the grinding wheel in a direction of the central axis of the gear cutter, and moving the grinding wheel in a translating direction that is a rotational tangent direction of the gear cutter. Thus, effects similar to those of the gear cutter machining apparatus can be attained.

A tool profile simulation apparatus according to another aspect of the present invention is configured to determine a profile of a gear cutter having a plurality of cutting teeth on its peripheral face.

The gear cutter is a tool to be used for skiving that is performed in a state in which a central axis of the gear cutter is inclined with respect to a central axis of a gear to be cut by the gear cutter, and is a tool to be manufactured by causing a grinding wheel formed into a disc profile to grind edge side faces of the gear cutter by rotating the gear cutter about the central axis of the gear cutter, rotating the grinding wheel about a central axis of the grinding wheel, relatively moving the grinding wheel in a direction of the central axis of the gear cutter, and relatively moving the grinding wheel in a translating direction that is a rotational tangent direction of the gear cutter in a state in which the central axis of the gear cutter and the central axis of the grinding wheel are inclined by a crossed axes angle from a state in which the central axis of the gear cutter and the central axis of the grinding wheel are orthogonal to each other.

The tool profile simulation apparatus includes an ideal edge profile computing unit, a machined edge profile computing unit, a tooth profile deviation computing unit, a tooth thickness deviation computing unit, a crossed axes angle gradual change amount computing unit, a movement amount gradual change amount computing unit, a modified machined edge profile computing unit, and a tool profile determining unit. The ideal edge profile computing unit is configured to compute an ideal edge profile of the gear cutter for each regrinding. The machined edge profile computing unit is configured to compute a machined edge profile of the gear cutter for each regrinding using the grinding wheel. The tooth profile deviation computing unit is configured to compute a deviation between a tooth profile obtained when the gear is cut by the ideal edge profile for each regrinding and a tooth profile obtained when the gear is cut by the machined edge profile for each regrinding. The tooth thickness deviation computing unit is configured to compute a deviation between a tooth thickness obtained when the gear is cut by the ideal edge profile for each regrinding and a tooth thickness obtained when the gear is cut by the machined edge profile for each regrinding. The crossed axes angle gradual change amount computing unit is configured to compute a gradual change amount of the crossed axes angle for optimizing the deviation between the tooth profiles for each regrinding. The movement amount gradual change amount computing unit is configured to compute a gradual change amount of a movement amount in the translating direction for optimizing the deviation between the tooth thicknesses for each regrinding. The modified machined edge profile computing unit is configured to compute a modified machined edge profile of the gear cutter for each regrinding using the grinding wheel based on the gradual change amount of the crossed axes angle for each regrinding and the gradual change amount of the movement amount in the translating direction for each regrinding. The tool profile determining unit is configured to determine the profile of the gear cutter based on the modified machined edge profile for each regrinding.

The tooth profile deviation computing unit is configured to compute a modified deviation between the tooth profile obtained when the gear is cut by the ideal edge profile for each regrinding and a tooth profile obtained when the gear is cut by the modified machined edge profile for each regrinding. The tooth thickness deviation computing unit is configured to compute a modified deviation between the tooth thickness obtained when the gear is cut by the ideal edge profile for each regrinding and a tooth thickness obtained when the gear is cut by the modified machined edge profile for each regrinding. The crossed axes angle gradual change amount computing unit is configured to recompute the gradual change amount of the crossed axes angle for each regrinding when the determined modified deviation between the tooth profiles for each regrinding falls out of a predetermined allowable range. The movement amount gradual change amount computing unit is configured to recompute the gradual change amount of the movement amount in the translating direction for each regrinding when the determined modified deviation between the tooth thicknesses for each regrinding falls out of a predetermined allowable range.

The tool profile simulation apparatus of the aspect described above repeatedly computes the gradual change amount of the crossed axes angle and the gradual change amount of the movement amount in the translating direction until the tooth profile deviation and the tooth thickness deviation fall within the predetermined allowable ranges. Thus, it is possible to attain the profile of the skiving gear cutter in which a larger regrinding amount can be secured.

A tool profile simulation method according to another aspect of the present invention is a method for determining a profile of a gear cutter having a plurality of cutting teeth on its peripheral face. The gear cutter is a tool to be used for skiving that is performed in a state in which a central axis of the gear cutter is inclined with respect to a central axis of a gear to be cut by the gear cutter, and is a tool to be manufactured by causing a grinding wheel formed into a disc profile to grind edge side faces of the gear cutter by rotating the gear cutter about the central axis of the gear cutter, rotating the grinding wheel about a central axis of the grinding wheel, relatively moving the grinding wheel in a direction of the central axis of the gear cutter, and relatively moving the grinding wheel in a translating direction that is a rotational tangent direction of the gear cutter in a state in which the central axis of the gear cutter and the central axis of the grinding wheel are inclined by a crossed axes angle from a state in which the central axis of the gear cutter and the central axis of the grinding wheel are orthogonal to each other.

The tool profile simulation method includes an ideal edge profile computing step, a machined edge profile computing step, a tooth profile deviation computing step, a tooth thickness deviation computing step, a crossed axes angle gradual change amount computing step, a movement amount gradual change amount computing step, a modified machined edge profile computing step, and a tool profile determining step. The ideal edge profile computing step is a step of computing an ideal edge profile of the gear cutter for each regrinding. The machined edge profile computing step is a step of computing a machined edge profile of the gear cutter for each regrinding using the grinding wheel. The tooth profile deviation computing step is a step of computing a deviation between a tooth profile obtained when the gear is cut by the ideal edge profile for each regrinding and a tooth profile obtained when the gear is cut by the machined edge profile for each regrinding. The tooth thickness deviation computing step is a step of computing a deviation between a tooth thickness obtained when the gear is cut by the ideal edge profile for each regrinding and a tooth thickness obtained when the gear is cut by the machined edge profile for each regrinding. The crossed axes angle gradual change amount computing step is a step of computing a gradual change amount of the crossed axes angle for optimizing the deviation between the tooth profiles for each regrinding. The movement amount gradual change amount computing step is a step of computing a gradual change amount of a movement amount in the translating direction for optimizing the deviation between the tooth thicknesses for each regrinding. The modified machined edge profile computing step is a step of computing a modified machined edge profile of the gear cutter for each regrinding using the grinding wheel based on the gradual change amount of the crossed axes angle for each regrinding and the gradual change amount of the movement amount in the translating direction for each regrinding. The tool profile determining step is a step of determining the profile of the gear cutter based on the modified machined edge profile for each regrinding.

The tooth profile deviation computing step includes computing a modified deviation between the tooth profile obtained when the gear is cut by the ideal edge profile for each regrinding and a tooth profile obtained when the gear is cut by the modified machined edge profile for each regrinding. The tooth thickness deviation computing step includes computing a modified deviation between the tooth thickness obtained when the gear is cut by the ideal edge profile for each regrinding and a tooth thickness obtained when the gear is cut by the modified machined edge profile for each regrinding. The crossed axes angle gradual change amount computing step includes recomputing the gradual change amount of the crossed axes angle for each regrinding when the determined modified deviation between the tooth profiles for each regrinding falls out of a predetermined allowable range. The movement amount gradual change amount computing step includes recomputing the gradual change amount of the movement amount in the translating direction for each regrinding when the determined modified deviation between the tooth thicknesses for each regrinding falls out of a predetermined allowable range. Thus, effects similar to those of the tool profile simulation apparatus can be attained.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1A is a view of a machining apparatus (grinding machine) that is configured to grind a gear cutter and includes a grinding wheel;

FIG. 1B is a view that is seen in a direction of an arrow IB in FIG. 1A;

FIG. 2 is a view of a gear cutter for cutting a gear, which is a gear cutter to be ground;

FIG. 3 is a view of the grinding wheel for grinding the gear cutter;

FIG. 4 is a side view of the gear to be cut;

FIG. 5 is a view of a machining apparatus (machining center) that is configured to cut the gear and includes the gear cutter;

FIG. 6 is a diagram illustrating a tool profile simulation apparatus for the gear cutter;

FIG. 7 is a flowchart for describing an operation of the tool profile simulation apparatus for the gear cutter;

FIG. 8 is a diagram for comparing ideal edge profiles and machined edge profiles;

FIG. 9 is a diagram illustrating a tooth profile deviation between an ideal tooth profile and a machined tooth profile of each of right and left tooth flanks of the gear;

FIG. 10 is a diagram illustrating a tooth profile deviation of a gear cut by a machined edge profile for each regrinding and a tooth profile deviation of a gear cut by a modified machined edge profile for each regrinding;

FIG. 11 is a diagram illustrating a tooth thickness deviation of the gear cut by the machined edge profile for each regrinding and a tooth thickness deviation of the gear cut by the modified machined edge profile for each regrinding;

FIG. 12A is a view for describing an operation to be performed when the grinding wheel grinds the gear cutter, and is a view of the peripheral face of the grinding wheel that is seen in a direction orthogonal to a central axis of the gear cutter;

FIG. 12B is a view for describing the operation to be performed when the grinding wheel grinds the gear cutter, and is a view that is seen in a direction of the central axis of the gear cutter;

FIG. 12C is a view for describing the operation to be performed when the grinding wheel grinds the gear cutter, and is a view of the end face of the grinding wheel that is seen in a direction orthogonal to the central axis of the gear cutter;

FIG. 13 is a diagram illustrating a relationship between a change amount of a crossed axes angle and a distance in a tool axis direction when the crossed axes angle is gradually changed;

FIG. 14 is a diagram illustrating a relationship between a change amount of a movement amount in a translating direction and the distance in the tool axis direction when the movement amount in the translating direction is gradually changed;

FIG. 15 is a diagram for comparing the ideal edge profiles and the modified machined edge profiles;

FIG. 16 is a diagram illustrating a controller of the gear cutter machining apparatus;

FIG. 17 is a flowchart for describing an operation of the controller of the gear cutter machining apparatus; and

FIG. 18 is a diagram illustrating another example of the controller of the gear cutter machining apparatus.

### DETAILED DESCRIPTION OF EMBODIMENTS

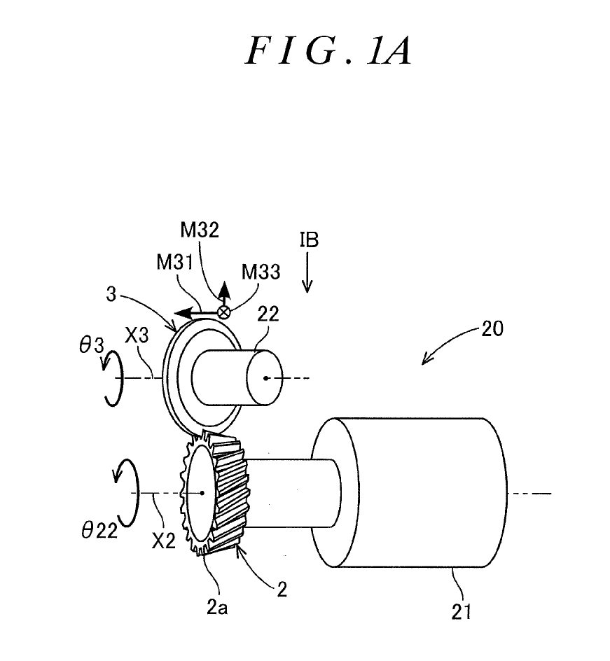

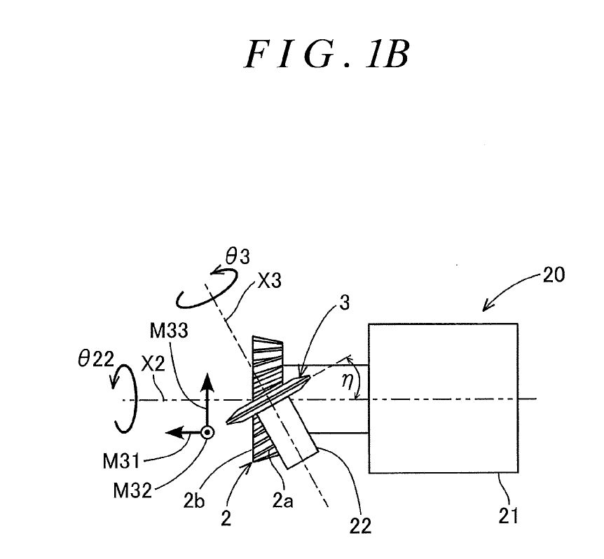

A machining apparatus 20 (grinding machine) is described with reference to FIG. 1A and FIG. 1B. The machining apparatus 20 causes a grinding wheel 3 to grind the edge side faces of a gear cutter 2 for cutting a gear 1 (see FIG. 4). In this embodiment, the machining apparatus 20 is a tool grinding machine, an angular wheel head cylindrical grinding machine, or the like. The machining apparatus 20 includes a controller 40. The controller 40 of the machining apparatus 20 is described later.

The machining apparatus 20 includes a spindle unit 21 configured to support the gear cutter 2 to be ground on a bed (not illustrated) so that the gear cutter 2 is rotatable about a central axis X2 of the gear cutter 2 (θ22). Further, the machining apparatus 20 includes a wheel spindle stock 22 configured to support the grinding wheel 3 so that the grinding wheel 3 is rotatable about a central axis X3 of the grinding wheel 3 (θ3). The controller 40 may be an embedded system in a computer numerical control (CNC) apparatus, a programmable logic controller (PLC), or the like, or may also be a personal computer, a server, or the like.

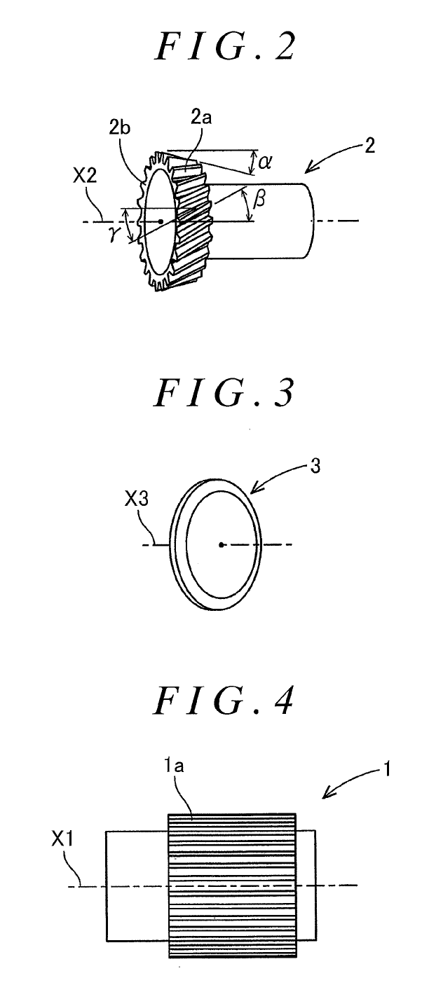

An overview of the profiles of the gear cutter 2, the grinding wheel 3, and the gear 1 is described with reference to FIG. 2 to FIG. 4. As illustrated in FIG. 2, the gear cutter 2 has a plurality of cutting teeth 2a on its outer peripheral face about the central axis X2. The gear cutter 2 has a cutting face 2b on its axial end face. The cutting face 2b may be tapered about the central axis X2 of the gear cutter 2, or may be formed into a profile of faces oriented in different directions for the individual cutting teeth 2a.

A circumscribed circle of the cutting teeth 2a of the gear cutter 2 is formed into a truncated cone profile. That is, the tip faces of the cutting teeth 2a are front flanks each having a front relief angle α with respect to the cutting face 2b. Thus, the distance from the central axis X2 of the gear cutter 2 to the edge top land gradually decreases with increasing distance from one end face of the cutting tooth 2a in an edge trace direction (equivalent to a gash direction).

The edge side faces of the cutting teeth 2a are side flanks each having a side relief angle γ with respect to the cutting face 2b. Further, the cutting teeth 2a each have a helix angle β with respect to the central axis X2. The helix angle β of the cutting tooth 2a varies as appropriate depending on a helix angle of a tooth 1a of the gear 1 and a crossed axes angle η between the gear 1 and the gear cutter 2 during cutting work. Therefore, the cutting tooth 2a may have no helix angle β. In this example, the helix angle β is equal to the crossed axes angle η.

As illustrated in FIG. 3, the grinding wheel 3 is configured to grind the gear cutter 2, and mainly grinds the edge side faces of the cutting teeth 2a of the gear cutter 2. The grinding wheel 3 is formed into a disc profile about the central axis X3. The outer peripheral face of the grinding wheel 3 is formed into a profile conforming to the profile of the gash of the gear cutter 2.

As illustrated in FIG. 4, the gear 1 to be cut has a plurality of teeth 1a on its peripheral face about a central axis X1. In this embodiment, an external gear is taken as an example of the gear 1, but an internal gear is also applicable. In FIG. 4, a spur gear is taken as an example of the gear 1, but various gears such as a helical gear are applicable.

As illustrated in FIG. 1A and FIG. 1B, the wheel spindle stock 22 is capable of adjusting the crossed axes angle η with respect to the spindle unit 21 during gear cutter machining (corresponding to a “crossed axes angle” of the present invention) (capable of adjusting the central axis X2 of the gear cutter 2 and the central axis X3 of the grinding wheel 3 so that the central axes X2 and X3 are inclined by the crossed axes angle η from a state in which the central axes X2 and X3 are orthogonal to each other). Further, the wheel spindle stock 22 is movable relative to the spindle unit 21 in directions of three orthogonal axes. The crossed axes angle η between the wheel spindle stock 22 and the spindle unit 21 is adjusted in accordance with the helix angle β of the gear cutter 2. In this example, the helix angle β is equal to the crossed axes angle η. It is only necessary that the spindle unit 21 and the wheel spindle stock 22 move relative to each other. Therefore, the spindle unit 21 may be movable.

By positioning the spindle unit 21 and the wheel spindle stock 22, the gear cutter 2 and the grinding wheel 3 are positioned in a state in which the central axis X2 of the gear cutter 2 and the central axis X3 of the grinding wheel 3 have the crossed axes angle η therebetween. In this state, the gear cutter 2 is rotated about the central axis X2 (θ22). The grinding wheel 3 is rotated about the central axis X3 (θ3). Further, the grinding wheel 3 moves in a direction of the central axis X2 of the gear cutter 2 (M31), a radial direction of the gear cutter 2 (M32), and a rotational tangent direction of the gear cutter 2 (translating direction) (M33) in synchronization with the rotation of the gear cutter 2. In this manner, the edge side faces of the cutting teeth 2a of the gear cutter 2 are ground.

The grinding wheel 3 may reciprocally move while rotating along the gash of the gear cutter 2, or may move in one direction alone. The grinding wheel 3 grinds both sides of the gash of the gear cutter 2 at the same time, but may grind one side of the gash. Even if the rotational direction of the gear cutter 2 is changed, the grinding wheel 3 may follow the change so that the grinding wheel 3 can grind the gash of the gear cutter 2 in accordance with the rotational direction of the gear cutter 2.

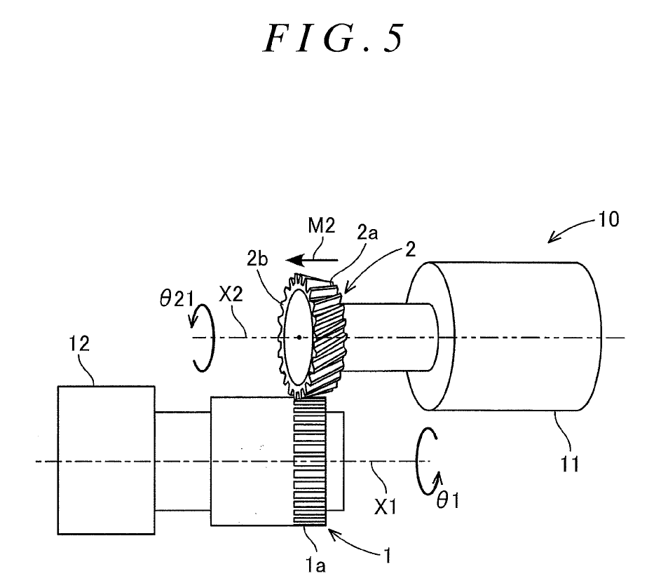

Next, a machining apparatus 10 is described with reference to FIG. 5. The machining apparatus 10 cuts the tooth side faces of the gear 1. In this embodiment, a machining center is taken as an example of the machining apparatus 10. In particular, a five-axis machining center is applied. The five-axis machining center has three orthogonal axes and two rotational axes in addition to a main spindle that supports a rotating tool.

The machining apparatus 10 includes a spindle unit 11 and the gear cutter 2. The spindle unit 11 is movable in directions of three orthogonal axes on a bed (not illustrated). The gear cutter 2 is attached to the tip of the spindle unit 11. Thus, the gear cutter 2 is rotatable about the central axis X2 of the gear cutter 2 (θ21), and is also movable in the directions of three orthogonal axes relative to the bed.

The machining apparatus 10 further includes a rotary table 12 configured to support the gear 1 to be cut. The rotary table 12 supports the gear 1 so that the gear 1 is rotatable about the central axis X1 of the gear 1 (θ1). The rotary table 12 is provided so as to be tiltable (inclinable) relative to the bed about one axis different from the rotational axis of the rotary table 12. That is, the rotary table 12 supports the gear 1 in a tiltable (inclinable) manner.

By positioning the spindle unit 11 and the rotary table 12, the gear 1 and the gear cutter 2 are positioned in a state in which the central axis X1 of the gear 1 and the central axis X2 of the gear cutter 2 have a crossed axes angle therebetween. In this state, the gear 1 is rotated about the central axis X1 (θ1). In synchronization with the rotation of the gear 1, the gear cutter 2 is rotated about the central axis X2 (θ21), and is relatively moved in a direction of the central axis X1 of the gear 1 (M2). In this manner, the gear 1 is formed.

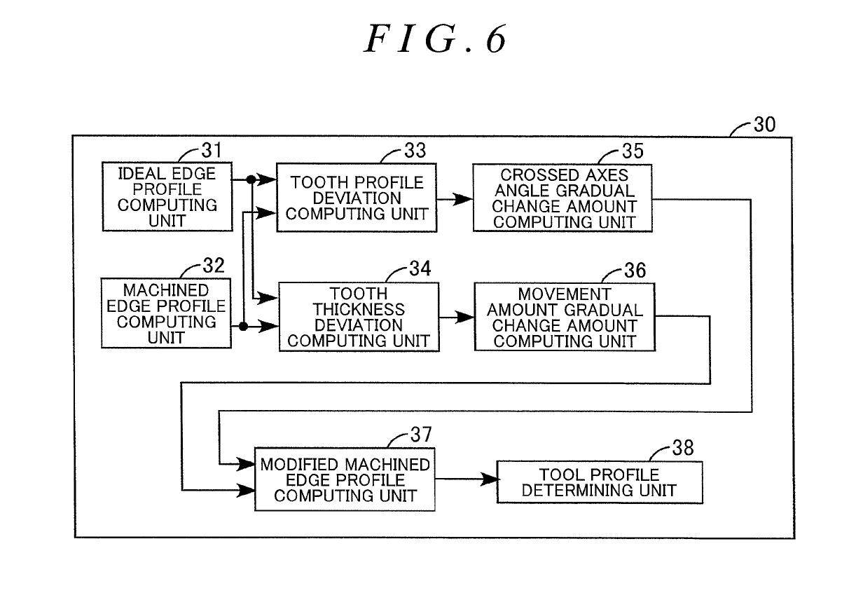

Next, a tool profile simulation apparatus for the gear cutter 2 is described with reference to FIG. 6. A tool profile simulation apparatus 30 includes an ideal edge profile computing unit 31, a machined edge profile computing unit 32, a tooth profile deviation computing unit 33, a tooth thickness deviation computing unit 34, a crossed axes angle gradual change amount computing unit 35, a movement amount gradual change amount computing unit 36, a modified machined edge profile computing unit 37, and a tool profile determining unit 38.

The tool profile simulation apparatus 30 may be provided in the machining apparatus 20 similarly to the controller 40. The tool profile simulation apparatus 30 may be an embedded system in a CNC apparatus, a PLC, or the like, or may also be a personal computer, a server, or the like. The tool profile simulation apparatus 30 is connected directly or via a network, and acquires gear conditions and tool conditions from the controller 40 or a simulation operator who sets simulation conditions. The tool profile simulation apparatus 30 determines information for the tool profile determining unit 38 by inputting the conditions to each of the computing units, and transmits the information to the controller 40 so as to perform machining, or displays the information for the simulation operator.

The ideal edge profile computing unit 31 computes an ideal edge profile of the gear cutter 2 for each regrinding. Specifically, the ideal edge profile computing unit 31 first determines an ideal edge profile of the gear cutter 2 before regrinding, and also determines the profile of the entire gear cutter 2 based on conditions regarding the gear 1 having a known profile and conditions regarding the gear cutter 2 for cutting the teeth 1a of the gear 1. Examples of the conditions regarding the gear 1 include a module, the number of teeth, a profile shift coefficient, a tip diameter, a root diameter, a reference diameter, a base diameter, a helix angle, a normal pressure angle, and a transverse pressure angle.

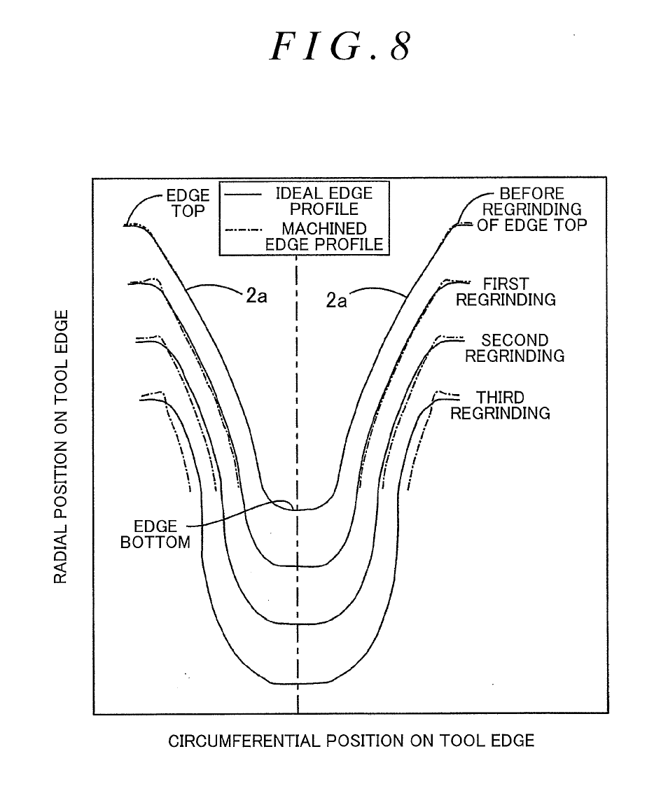

Examples of the conditions regarding the gear cutter 2 include the number of edges, an edge top diameter, a reference diameter, a base diameter, a rake angle, a helix angle, a front relief angle, a side relief angle, and a transverse pressure angle. The ideal edge profile computing unit 31 geometrically determines the ideal edge profile of the gear cutter 2 for each regrinding (profile illustrated below each continuous line in FIG. 8) based on the ideal edge profile of the gear cutter 2 before regrinding, the edge top diameter, a distance between the centers of the gear 1 and the gear cutter 2, the profile of the entire gear cutter 2, a regrinding amount, and the like.

The machined edge profile computing unit 32 computes an edge profile of the gear cutter 2 machined by the grinding wheel 3 for each regrinding (machined edge profile). Specifically, the machined edge profile computing unit 32 determines the machined edge profile of the gear cutter 2 for each regrinding by simulating the grinding of the gear cutter 2 using the designed grinding wheel 3. Long dashed short dashed lines in FIG. 8 indicate a contour of the machined edge profile, and the machined edge profile is illustrated below the long dashed short dashed lines. FIG. 8 illustrates a machined edge profile ranging from the edge top to some midpoint in a path toward the edge bottom.

For example, the following method is provided as a method for designing the grinding wheel 3. The method involves determining a profile of the outer peripheral face of the grinding wheel 3 for grinding the edge side faces of the gear cutter 2 having a known profile (profile obtained by the grinding simulation) that is a target of the grinding. By grinding the edge side faces of the gear cutter 2, ridge lines between the edge side faces of the cutting tooth 2a and the cutting face 2b are ground in addition to the edge side faces of the cutting tooth 2a of the gear cutter 2. The following designing method is described as a method for designing the profile of the grinding wheel 3 in order to design the profile of the ridge lines between the edge side faces of the cutting tooth 2a of the gear cutter 2 and the cutting face 2b.

For one ground point on the ridge lines between the edge side faces of the gear cutter 2 and the cutting face 2b, a grinding point (outer peripheral profile point) where the ground point can be ground is determined. This processing (processing for one ground point) is performed for a plurality of ground points, thereby acquiring a plurality of grinding points (outer peripheral profile points). Lastly, the grinding points are connected together into a continuous line, thereby determining the profile of the grinding wheel 3.

For example, the following method is provided as a method for simulating the grinding of the gear cutter 2 using the grinding wheel 3. For one cut point on the tooth 1a of the gear 1 having a known profile, a cutting point (edge profile point) where the cut point can be cut is determined. This processing (processing for one cut point) is performed for a plurality of cut points, thereby acquiring a plurality of cutting points (edge profile points). Lastly, the cutting points are connected together into a continuous line, thereby determining the machined edge profile of the gear cutter 2.

The tooth profile deviation computing unit 33 computes a deviation between a tooth profile obtained when the gear 1 is cut by the ideal edge profile for each regrinding and a tooth profile obtained when the gear 1 is cut by the machined edge profile for each regrinding. Further, the tooth profile deviation computing unit 33 computes a modified deviation described later between the tooth profile obtained when the gear 1 is cut by the ideal edge profile for each regrinding and a tooth profile obtained when the gear 1 is cut by a modified machined edge profile described later for each regrinding.

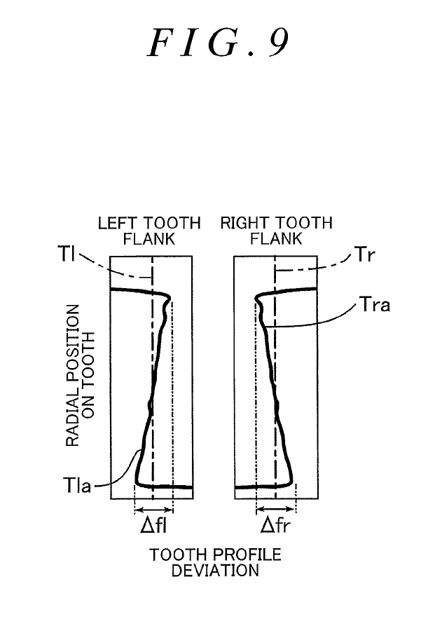

Specifically, as illustrated in FIG. 9, tooth profiles of right and left tooth flanks of the gear 1, which are obtained when the gear 1 is cut by the ideal edge profile before regrinding, are converted into long dashed short dashed lines Tr and Tl. In this case, tooth profiles of the right and left tooth flanks of the gear 1, which are obtained when the gear 1 is cut by a machined edge profile before regrinding (machined edge profile immediately after the machining performed by using the grinding wheel 3), are represented by continuous lines Tra and Tla through the conversion. Thus, the right and left tooth profile deviations of the gear 1 are maximum change amounts Δfr and Δfl of the tooth profiles of the right and left tooth flanks of the gear 1, which are represented by the continuous lines Tra and Tla.

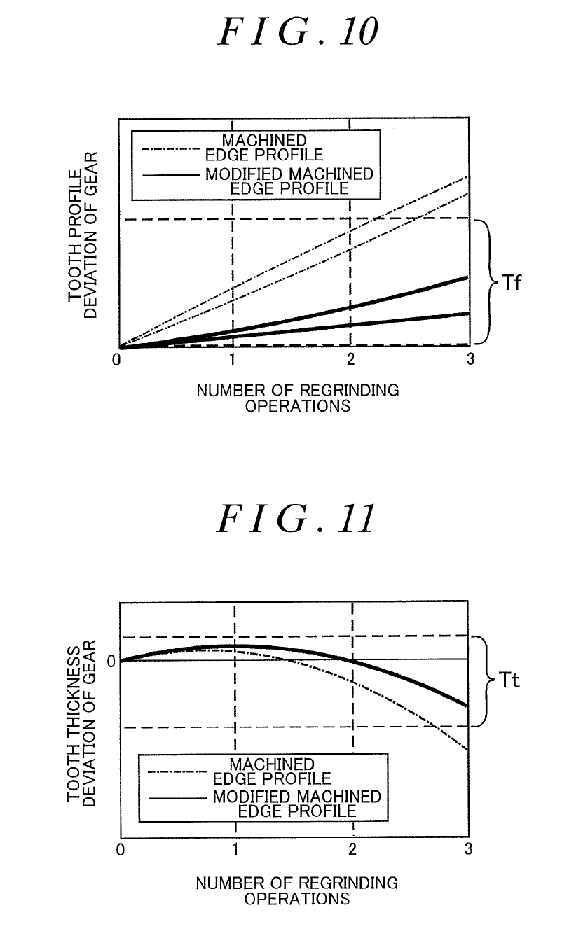

Similar processing is performed to determine right and left tooth profile deviations based on tooth profiles of the right and left tooth flanks of the gear 1, which are obtained when the gear 1 is cut by the machined edge profile for each regrinding. As a result, as illustrated in FIG. 10, the right and left tooth profile deviations of the gear 1 for each regrinding (long dashed short dashed lines in FIG. 10) abruptly change (increase) along with an increase in the regrinding amount. In this example, the right and left tooth profile deviations of the gear 1 fall out of an allowable range Tf when the number of regrinding operations is three. Thus, the tool reaches the end of its life. The tooth profile deviation is substantially zero when the gear 1 is cut by the ideal edge profile for each regrinding.

The tooth thickness deviation computing unit 34 computes a deviation between a tooth thickness obtained when the gear 1 is cut by the ideal edge profile for each regrinding and a tooth thickness obtained when the gear 1 is cut by the machined edge profile for each regrinding. Further, the tooth thickness deviation computing unit 34 computes a modified deviation described later between the tooth thickness obtained when the gear 1 is cut by the ideal edge profile for each regrinding and a tooth thickness obtained when the gear 1 is cut by the modified machined edge profile described later for each regrinding. Specifically, the tooth thickness of the gear 1 is represented by a distance between intersections of the reference circle and the right and left tooth flanks. As a result, as illustrated in FIG. 11, the tooth thickness deviation of the gear 1 for each regrinding (long dashed short dashed line in FIG. 11) abruptly changes (temporarily increases and then abruptly decreases) along with the increase in the regrinding amount. In this example, the tooth thickness deviation of the gear 1 falls out of an allowable range Tt when the number of regrinding operations is three. Thus, the tool reaches the end of its life. The tooth thickness deviation is substantially zero when the gear 1 is cut by the ideal edge profile for each regrinding.

In order to increase the number of regrinding operations for the gear cutter 2, it is necessary to suppress the abrupt change in the right and left tooth profile deviations of the gear 1 along with the increase in the regrinding amount, and to keep the right and left tooth profile deviations of the gear 1 within the allowable range Tf at a desired number of regrinding operations. Further, in order to increase the number of regrinding operations for the gear cutter 2, it is necessary to suppress the abrupt change in the tooth thickness deviation of the gear 1 along with the increase in the regrinding amount, and to keep the tooth thickness deviation of the gear 1 within the allowable range Tt at a desired number of regrinding operations. In a related-art operation for grinding the gear cutter 2 by using the grinding wheel 3 (Niles tool grinding operation), the inventors have found the existence of parameters capable of optimizing the tooth profile deviation and the tooth thickness deviation. The parameters are described below.

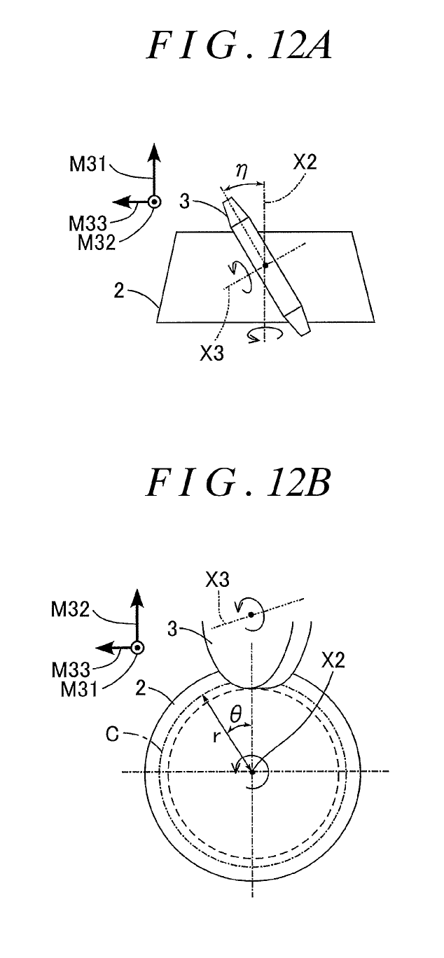

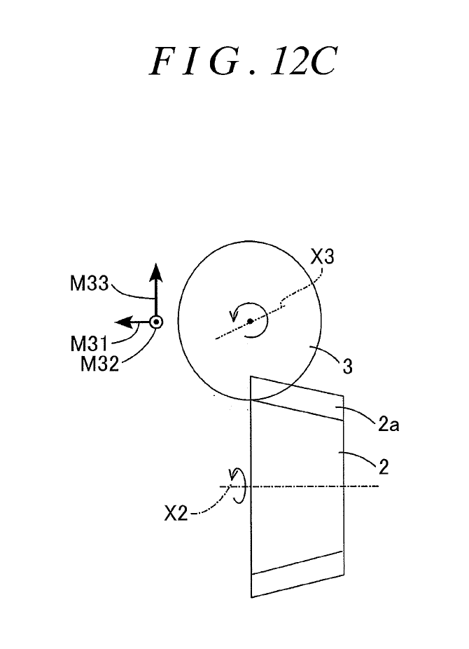

As illustrated in FIG. 12A, FIG. 12B, and FIG. 12C, the operation for grinding the gear cutter 2 by using the grinding wheel 3 is an operation of causing the grinding wheel 3 to perform through-feed grinding along the gash of the gear cutter 2, and includes the following three operations. The first operation is an operation of forming an edge profile of the gear cutter 2. Specifically, the first operation is an operation of moving the grinding wheel 3 in the translating direction without a slip relative to a reference circle C (rolling circle) of the gear cutter 2, that is, an operation of moving the grinding wheel 3 by rθ in the translating direction M33 when the radius of the reference circle is represented by “r” and the rotational angle of the gear cutter 2 is represented by “θ”.

The second operation is an operation of forming relief angles of the gear cutter 2. Specifically, the second operation is an operation of changing the infeed amount of the grinding wheel 3 in accordance with the axial direction in order to form the front relief angle α and the side relief angle γ at the same time. The third operation is an operation of forming a helix angle of the gear cutter 2. Specifically, the third operation is an operation of correcting the movement of the grinding wheel 3 in the translating direction M33 by arranging the grinding wheel 3 and the gear cutter 2 so that the crossed axes angle η is formed therebetween. Based on the grinding operation described above, the crossed axes angle η is a parameter capable of optimizing the tooth profile deviation, and the movement amount in the translating direction M33 is a parameter capable of optimizing the tooth thickness deviation.

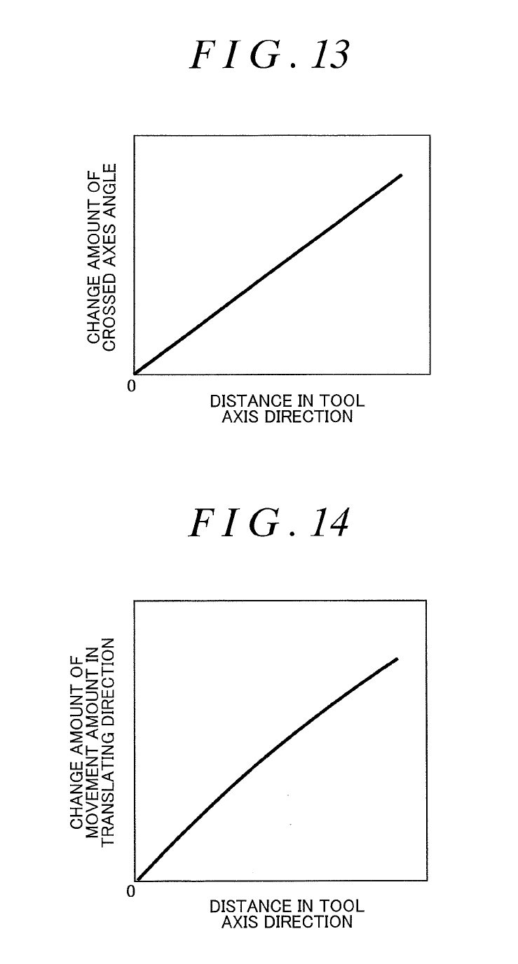

The crossed axes angle gradual change amount computing unit 35 computes a gradual change amount of the crossed axes angle η for optimizing the tooth profile deviation for each regrinding. The crossed axes angle gradual change amount computing unit 35 recomputes the gradual change amount of the crossed axes angle η for each regrinding when the modified deviation between the tooth profiles for each regrinding, which is determined by the tooth profile deviation computing unit 33, falls out of a predetermined allowable range. As a specific method for gradually changing the crossed axes angle, as illustrated in FIG. 13, the crossed axes angle is linearly changed while the grinding wheel 3 is moved in the tool axis direction along the edge trace of the cutting tooth 2a from the position of the cutting face 2b of the gear cutter 2 (position where the distance in the tool axis direction is zero in FIG. 13).

That is, when the grinding is performed for a right edge face of one cutting tooth 2a of the gear cutter 2 with respect to the movement direction of the grinding wheel 3, the crossed axes angle at the start of grinding is changed so that the change amount of the crossed axes angle linearly increases counterclockwise with respect to the central axis X2 of the gear cutter 2. When the grinding is performed for a left edge face of one cutting tooth 2a of the gear cutter 2 with respect to the movement direction of the grinding wheel 3, the crossed axes angle at the start of grinding is changed so that the change amount of the crossed axes angle linearly increases clockwise with respect to the central axis X2 of the gear cutter 2.

The movement amount gradual change amount computing unit 36 computes a gradual change amount of the movement amount in the translating direction M33 for optimizing the deviation for each regrinding. The movement amount gradual change amount computing unit 36 recomputes the gradual change amount of the movement amount in the translating direction M33 for each regrinding when the modified deviation between the tooth thicknesses for each regrinding, which is determined by the tooth thickness deviation computing unit 34, falls out of a predetermined allowable range. As a specific method for gradually changing the movement amount in the translating direction, as illustrated in FIG. 14, the movement amount in the translating direction is changed along a quadratic curve while the grinding wheel 3 is moved in the tool axis direction along the edge trace of the cutting tooth 2a from the position of the cutting face 2b of the gear cutter 2 (position where the distance in the tool axis direction is zero in FIG. 14).

That is, when the grinding is performed for a right edge face of one cutting tooth 2a of the gear cutter 2 with respect to the movement direction of the grinding wheel 3, the movement amount in the translating direction M33 is changed so that the change amount of the movement amount in the translating direction M33 increases along the quadratic curve in a leftward direction. When the grinding is performed for a left edge face of one cutting tooth 2a of the gear cutter 2 with respect to the movement direction of the grinding wheel 3, the movement amount in the translating direction M33 is changed so that the change amount of the movement amount in the translating direction M33 increases along the quadratic curve in a rightward direction.

The modified machined edge profile computing unit 37 computes a modified machined edge profile of the gear cutter 2 for each regrinding by simulating the grinding of the gear cutter 2 using the grinding wheel 3 (in the same manner as that of the simulation used in the machined edge profile computing unit 32) based on the gradual change amount of the crossed axes angle η for each regrinding and the gradual change amount of the movement amount in the translating direction M33 for each regrinding. The tool profile determining unit 38 determines a profile of the gear cutter 2 based on the modified machined edge profile for each regrinding.

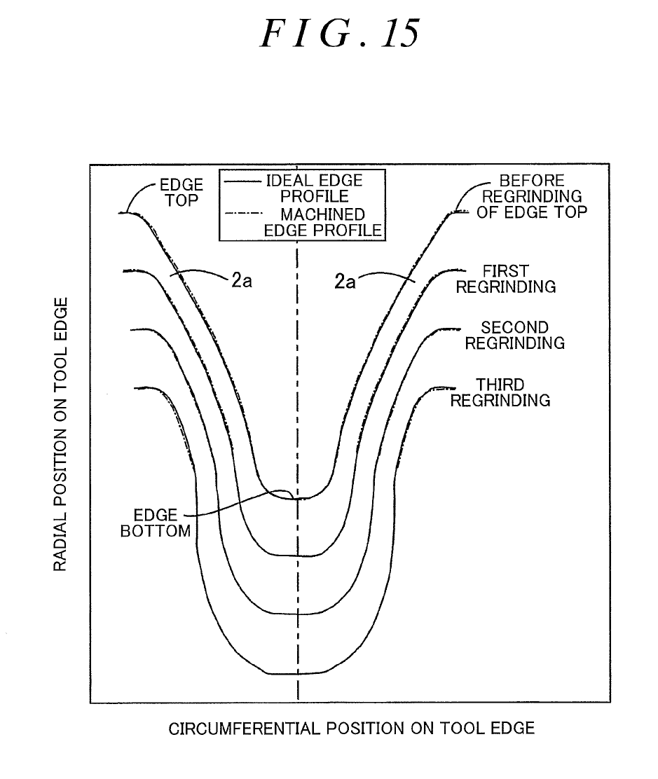

As a specific result, as illustrated in FIG. 15, a contour of the modified machined edge profile indicated by the long dashed short dashed lines is closer to the contour of the ideal edge profile indicated by the continuous line. The long dashed short dashed lines in FIG. 15 indicate the contour of the modified machined edge profile, and the modified machined edge profile is illustrated below the long dashed short dashed lines. FIG. 15 illustrates a modified machined edge profile ranging from the edge top to some midpoint in the path toward the edge bottom. The deviation between the modified machined edge profile and the ideal edge profile illustrated in FIG. 15 is smaller than the deviation between the machined edge profile and the ideal edge profile illustrated in FIG. 8.

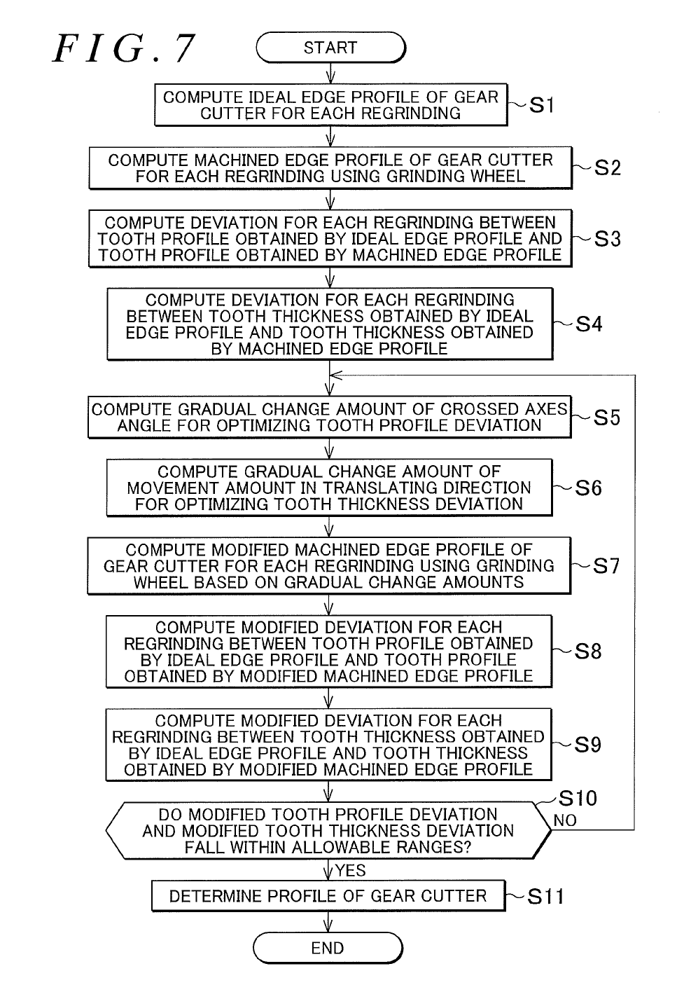

Next, an operation (simulation method) of the tool profile simulation apparatus for the gear cutter 2 (hereinafter referred to simply as “apparatus”) 30 is described with reference to FIG. 7. The apparatus 30 computes an ideal edge profile of the gear cutter 2 for each regrinding (Step S1 of FIG. 7; ideal edge profile computing step), and computes a machined edge profile of the gear cutter 2 for each regrinding using the grinding wheel 3 (Step S2 of FIG. 7; machined edge profile computing step). Then, the apparatus 30 computes deviations for each regrinding between a tooth profile and a tooth thickness of the gear 1 machined by the ideal edge profile and a tooth profile and a tooth thickness of the gear 1 machined by the machined edge profile (Steps S3 and S4 of FIG. 7; tooth profile deviation computing step and tooth thickness deviation computing step).

The apparatus 30 computes a gradual change amount of the crossed axes angle η for optimizing the tooth profile deviation and a gradual change amount of the movement amount in the translating direction M33 for optimizing the tooth thickness deviation (Steps S5 and S6 of FIG. 7; crossed axes angle gradual change amount computing step and movement amount gradual change amount computing step). Then, the apparatus 30 computes a modified machined edge profile of the gear cutter 2 for each regrinding using the grinding wheel 3 based on the gradual change amounts (Step S7 of FIG. 7; modified machined edge profile computing step). Then, the apparatus 30 computes modified deviations for each regrinding between the tooth profile and the tooth thickness of the gear 1 machined by the ideal edge profile and a tooth profile and a tooth thickness of the gear 1 machined by the modified machined edge profile (Steps S8 and S9 of FIG. 7; tooth profile deviation computing step and tooth thickness deviation computing step).

The apparatus 30 determines whether the determined modified tooth profile deviation and the determined modified tooth thickness deviation fall within the allowable ranges (Step S10 of FIG. 7). When the modified tooth profile deviation and the modified tooth thickness deviation fall out of the allowable ranges, the apparatus 30 returns to Step S5 to repeat the processing described above. When the modified tooth profile deviation and the modified tooth thickness deviation fall within the allowable ranges in Step S10, the apparatus 30 determines a profile of the gear cutter 2 based on the modified machined edge profile for each regrinding (Step S11 of FIG. 7; tool profile determining step), and terminates all the processing.

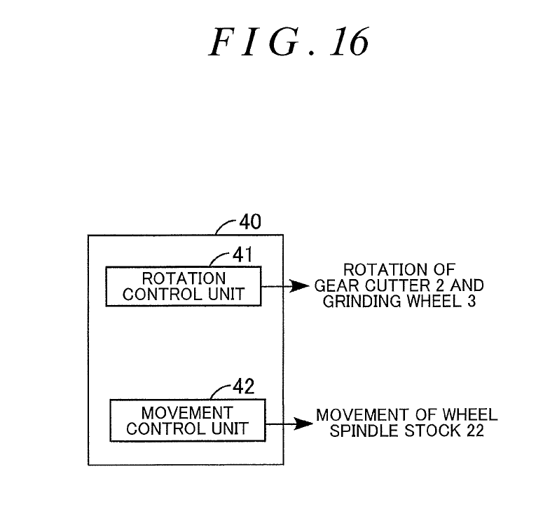

Next, the controller 40 of the machining apparatus 20 for the gear cutter 2 is described with reference to FIG. 16. As illustrated in FIG. 16, the controller 40 of the machining apparatus 20 for the gear cutter 2 includes a rotation control unit 41 and a movement control unit 42.

The rotation control unit 41 controls driving of a rotational drive motor (not illustrated) configured to rotate the gear cutter 2 provided on the spindle unit 21 about the central axis X2 (θ22), and a rotational drive motor (not illustrated) configured to rotate the grinding wheel 3 provided on the wheel spindle stock 22 about the central axis X3 (θ3).

The movement control unit 42 controls driving of a ball screw mechanism and a drive motor (not illustrated) configured to move the wheel spindle stock 22 in each of the direction of the central axis X2 of the gear cutter 2 (M31), the radial direction of the gear cutter 2 (M32), and the rotational tangent direction of the gear cutter 2 (translating direction) (M33). Further, the movement control unit 42 controls driving of a drive motor (not illustrated) configured to pivot the rotary table 12.

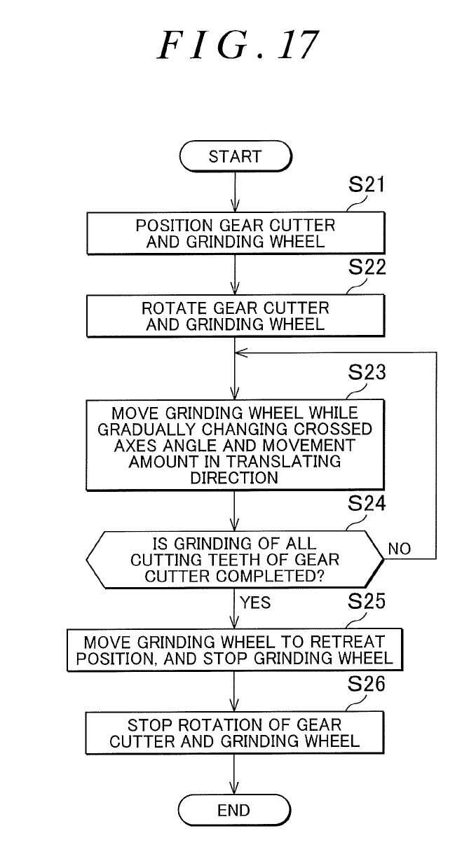

Next, an operation of the controller 40 of the machining apparatus 20 for the gear cutter 2 is described with reference to FIG. 17. The controller 40 controls the movement of the wheel spindle stock 22 to move the grinding wheel 3 toward the cutting face of the gear cutter 2, thereby positioning the gear cutter 2 and the grinding wheel 3 in a state in which the central axis X2 of the gear cutter 2 and the central axis X3 of the grinding wheel 3 have a crossed axes angle therebetween (Step S21 of FIG. 17). In this state, the gear cutter 2 is rotated about the central axis X2 (θ22), and the grinding wheel 3 is rotated about the central axis X3 (θ3) (Step S22 of FIG. 17; rotation control step).

The controller 40 moves the grinding wheel 3 in the translating direction M33 without a slip relative to the reference circle (rolling circle) of the gear cutter 2, and also moves the grinding wheel 3 in the axial direction M31 of the gear cutter 2 while changing the infeed amount of the grinding wheel 3 in accordance with the axial direction M31 of the gear cutter 2. During the movement, the movement amount in the translating direction M33 is gradually changed while gradually changing the crossed axes angle η (Step S23 of FIG. 17; movement control step). The gradual change amount of the crossed axes angle and the gradual change amount of the movement amount in the translating direction are determined in advance by the tool profile simulation apparatus 30, and are stored in the controller 40.

The controller 40 determines whether the grinding of all the cutting teeth 2a of the gear cutter 2 is completed (Step S24 of FIG. 17). When the grinding of all the cutting teeth 2a of the gear cutter 2 is not completed, the controller 40 returns to Step S23 to repeat the processing described above. When the grinding of all the cutting teeth 2a of the gear cutter 2 is completed in Step S24, the controller 40 moves the grinding wheel 3 to a retreat position, and stops the grinding wheel 3 (Step S25 of FIG. 17). The controller 40 stops the rotation of the grinding wheel 3 and the gear cutter 2 (Step S26 of FIG. 17), and terminates all the processing.

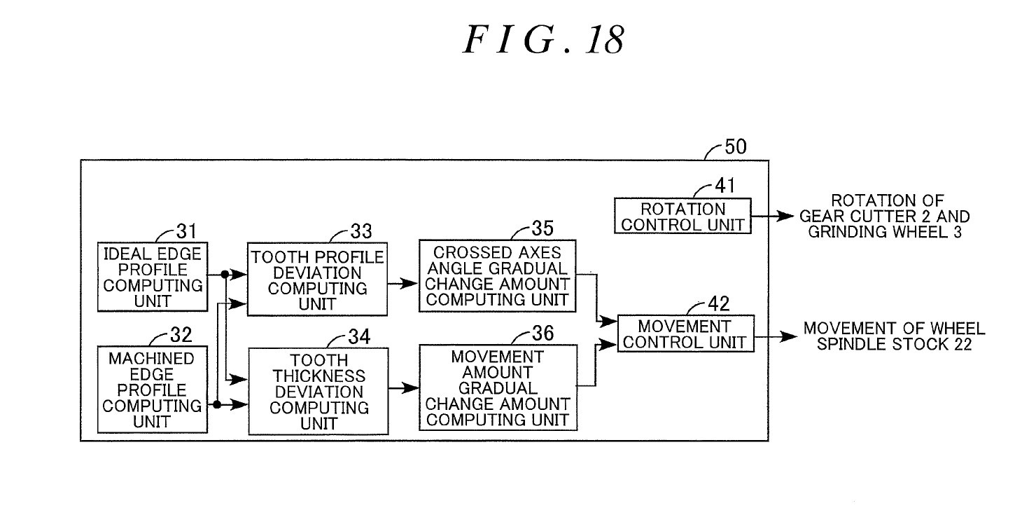

The controller 40 described above is configured to control the machining of the gear cutter 2 by inputting the gradual change amount of the crossed axes angle η and the gradual change amount of the movement amount in the translating direction M33, which are determined by the tool profile simulation apparatus 30. As illustrated in FIG. 18, a controller 50 having a part of the functions of the tool profile simulation apparatus 30 may be employed instead.

The controller 50 includes the rotation control unit 41, the movement control unit 42, the ideal edge profile computing unit 31, the machined edge profile computing unit 32, the tooth profile deviation computing unit 33, the tooth thickness deviation computing unit 34, the crossed axes angle gradual change amount computing unit 35, and the movement amount gradual change amount computing unit 36. The controller 50 has a part of the functions of the tool profile simulation apparatus 30 (units represented by the same numerals). The controller 50 controls the machining of the gear cutter 2 by computing, in itself, the gradual change amount of the crossed axes angle η and the gradual change amount of the movement amount in the translating direction M33.

In the embodiment described above, the grinding is performed by using both of the gradual change amount of the crossed axes angle η and the gradual change amount of the movement amount in the translating direction M33. The grinding may be performed by using one of the gradual change amounts. That is, when the tooth profile deviation of the gear 1 is significant, the grinding may be performed by using the gradual change amount of the crossed axes angle η, and when the tooth thickness deviation of the gear 1 is significant, the grinding may be performed by using the gradual change amount of the movement amount in the translating direction M33.

Description is given of the case where the change amount of the crossed axes angle is linearly changed relative to the distance in the tool axis direction when the crossed axes angle is gradually changed. When the tooth profile deviation cannot be suppressed, the change amount of the crossed axes angle may be changed along an n-th order curve (n is an integer). Description is given of the case where the change amount of the movement amount in the translating direction is changed along the quadratic curve relative to the distance in the tool axis direction when the movement amount in the translating direction is gradually changed. When the tooth thickness deviation cannot be suppressed, the change amount of the movement amount in the translating direction may be changed linearly or along a cubic or other higher order curve. When the regrinding amount increases, the tooth profile deviation is uneven and complex in a tooth trace direction and a facewidth direction. Therefore, the order of the curve may be set based on the tooth profile deviation.

The gear cutter machining apparatus 20 of this embodiment includes the grinding wheel 3 and the controller 40. The grinding wheel 3 is formed into a disc profile. The controller 40 controls the grinding wheel 3 to grind the edge side faces of the gear cutter 2 having the plurality of cutting teeth 2a on its peripheral face in a state in which the central axis X2 of the gear cutter 2 and the central axis X3 of the grinding wheel 3 are inclined by the crossed axes angle η from a state in which the central axis X2 of the gear cutter 2 and the central axis X3 of the grinding wheel 3 are orthogonal to each other. The gear cutter 2 is a tool to be used for skiving that is performed in a state in which the central axis X2 of the gear cutter 2 is inclined with respect to the central axis X1 of the gear 1 to be cut by the gear cutter 2.

The controller 40 includes the rotation control unit 41 and the movement control unit 42. The rotation control unit 41 rotates the gear cutter 2 about the central axis X2 of the gear cutter 2, and rotates the grinding wheel 3 about the central axis X3 of the grinding wheel 3. The movement control unit 42 gradually changes the crossed axes angle η when relatively moving the grinding wheel 3 in the direction of the central axis X2 of the gear cutter 2, and moves the grinding wheel 3 in the translating direction M33 that is the rotational tangent direction of the gear cutter 2.

When the skiving gear cutter 2 is manufactured by a pinion type cutter machining method, the thickness of the tool edge decreases and the outside diameter of the tool also decreases due to the regrinding. Therefore, the gear 1 machined by the reground skiving gear cutter 2 has a tooth profile deviation from an ideal gear 1. The tooth profile deviation tends to increase as the regrinding amount increases. The tooth profile deviation depends on the crossed axes angle η formed between the central axis X2 of the gear cutter 2 and the central axis X3 of the grinding wheel 3. By grinding the gear cutter 2 while gradually changing the crossed axes angle η in accordance with the tooth profile deviation, the increase in the tooth profile deviation can be suppressed. Thus, the machining apparatus 20 for the gear cutter 2 of this embodiment can machine a skiving gear cutter 2 in which a large regrinding amount can be secured.

The movement control unit 42 performs control for gradually increasing the change amount of the crossed axes angle η when relatively moving the grinding wheel 3 from one end face toward the other end face of the gear cutter 2 in the direction of the central axis X2 of the gear cutter 2. Thus, it is possible to reduce the tooth profile deviation that tends to increase in the direction of the central axis X2 of the gear cutter 2.

The movement control unit 42 gradually changes the movement amount in the translating direction M33 that is the rotational tangent direction of the gear cutter 2 when moving the grinding wheel 3 in the translating direction M33. The gear 1 machined by the reground skiving gear cutter 2 has a tooth thickness deviation from an ideal gear 1. The tooth thickness deviation tends to increase as the regrinding amount increases. The tooth thickness deviation depends on the movement amount in the translating direction M33 that is the rotational tangent direction of the gear cutter 2. By grinding the gear cutter 2 while gradually changing the movement amount in the translating direction M33 in accordance with the tooth thickness deviation, the increase in the tooth thickness deviation can be suppressed. Thus, the machining apparatus 20 for the gear cutter 2 of this embodiment can machine a skiving gear cutter 2 in which a large regrinding amount can be secured.

The movement control unit 42 performs control for gradually increasing the change amount of the movement amount in the translating direction M33 when relatively moving the grinding wheel 3 from one end face toward the other end face of the gear cutter 2 in the direction of the central axis X2 of the gear cutter 2. Thus, it is possible to reduce the tooth thickness deviation that tends to increase in the direction of the central axis X2 of the gear cutter 2.

The controller 40 includes the ideal edge profile computing unit 31, the machined edge profile computing unit 32, the tooth profile deviation computing unit 33, and the crossed axes angle gradual change amount computing unit 35. The ideal edge profile computing unit 31 computes the ideal edge profile of the gear cutter 2 for each regrinding. The machined edge profile computing unit 32 computes the machined edge profile of the gear cutter 2 for each regrinding using the grinding wheel 3. The tooth profile deviation computing unit 33 computes the deviation between the tooth profile obtained when the gear 1 is cut by the ideal edge profile for each regrinding and the tooth profile obtained when the gear 1 is cut by the machined edge profile for each regrinding. The crossed axes angle gradual change amount computing unit 35 computes the gradual change amount of the crossed axes angle η for optimizing the deviation between the tooth profiles for each regrinding. Thus, the controller 40 can control the grinding of the gear cutter 2 based on the determined gradual change amount of the crossed axes angle η. Accordingly, it is possible to machine a gear cutter 2 in which the increase in the tooth profile deviation is suppressed.

The controller 40 includes the ideal edge profile computing unit 31, the machined edge profile computing unit 32, the tooth profile deviation computing unit 33, the tooth thickness deviation computing unit 34, the crossed axes angle gradual change amount computing unit 35, and the movement amount gradual change amount computing unit 36. The ideal edge profile computing unit 31 computes the ideal edge profile of the gear cutter 2 for each regrinding. The machined edge profile computing unit 32 computes the machined edge profile of the gear cutter 2 for each regrinding using the grinding wheel 3. The tooth profile deviation computing unit 33 computes the deviation between the tooth profile obtained when the gear 1 is cut by the ideal edge profile for each regrinding and the tooth profile obtained when the gear 1 is cut by the machined edge profile for each regrinding. The tooth thickness deviation computing unit 34 computes the deviation between the tooth thickness obtained when the gear 1 is cut by the ideal edge profile for each regrinding and the tooth thickness obtained when the gear 1 is cut by the machined edge profile for each regrinding. The crossed axes angle gradual change amount computing unit 35 computes the gradual change amount of the crossed axes angle η for optimizing the deviation between the tooth profiles for each regrinding. The movement amount gradual change amount computing unit 36 computes the gradual change amount of the movement amount in the translating direction M33 for optimizing the deviation between the tooth thicknesses for each regrinding. Thus, the controller 40 can control the grinding of the gear cutter 2 based on the determined gradual change amount of the crossed axes angle η and the determined gradual change amount of the movement amount in the translating direction M33. Accordingly, it is possible to machine a gear cutter 2 in which the increase in the tooth profile deviation and the increase in the tooth thickness deviation are suppressed.

The gear cutter machining method of this embodiment uses the grinding wheel 3 formed into a disc profile, and causes the grinding wheel 3 to grind the edge side faces of the gear cutter 2 having the plurality of cutting teeth 2a on its peripheral face in a state in which the central axis X2 of the gear cutter 2 and the central axis X3 of the grinding wheel 3 are inclined by the crossed axes angle η from a state in which the central axis X2 of the gear cutter 2 and the central axis X3 of the grinding wheel 3 are orthogonal to each other. The gear cutter 2 is a tool to be used for skiving that is performed in a state in which the central axis X2 of the gear cutter 2 is inclined with respect to the central axis X1 of the gear 1 to be cut by the gear cutter 2.

The gear cutter machining method includes the rotation control step and the movement control step. The rotation control step is a step of rotating the gear cutter 2 about the central axis X2 of the gear cutter 2, and rotating the grinding wheel 3 about the central axis X3 of the grinding wheel 3. The movement control step is a step of gradually changing the crossed axes angle η when relatively moving the grinding wheel 3 in the direction of the central axis X2 of the gear cutter 2, and moving the grinding wheel 3 in the translating direction M33 that is the rotational tangent direction of the gear cutter 2. Thus, effects similar to those of the gear cutter machining apparatus 20 can be attained.

The movement control step includes gradually changing the movement amount in the translating direction M33 that is the rotational tangent direction of the gear cutter 2 when moving the grinding wheel 3 in the translating direction M33. Thus, it is possible to reduce the tooth thickness deviation that tends to increase in the direction of the central axis X2 of the gear cutter 2.

The tool profile simulation apparatus 30 for the gear cutter 2 of this embodiment determines the profile of the gear cutter 2 having the plurality of cutting teeth 2a on its peripheral face. The gear cutter 2 is a tool to be used for skiving that is performed in a state in which the central axis X2 of the gear cutter 2 is inclined with respect to the central axis X1 of the gear 1 to be cut by the gear cutter 2, and is a tool to be manufactured by causing the grinding wheel 3 formed into a disc profile to grind the edge side faces of the gear cutter 2 by rotating the gear cutter 2 about the central axis X2 of the gear cutter 2, rotating the grinding wheel 3 about the central axis X3 of the grinding wheel 3, relatively moving the grinding wheel 3 in the direction of the central axis X2 of the gear cutter 2, and relatively moving the grinding wheel 3 in the translating direction M33 that is the rotational tangent direction of the gear cutter 2 in a state in which the central axis X2 of the gear cutter 2 and the central axis X3 of the grinding wheel 3 are inclined by the crossed axes angle η from a state in which the central axis X2 of the gear cutter 2 and the central axis X3 of the grinding wheel 3 are orthogonal to each other.

The tool profile simulation apparatus 30 includes the ideal edge profile computing unit 31, the machined edge profile computing unit 32, the tooth profile deviation computing unit 33, the tooth thickness deviation computing unit 34, the crossed axes angle gradual change amount computing unit 35, the movement amount gradual change amount computing unit 36, the modified machined edge profile computing unit 37, and the tool profile determining unit 38. The ideal edge profile computing unit 31 computes the ideal edge profile of the gear cutter 2 for each regrinding. The machined edge profile computing unit 32 computes the machined edge profile of the gear cutter 2 for each regrinding using the grinding wheel 3. The tooth profile deviation computing unit 33 computes the deviation between the tooth profile obtained when the gear 1 is cut by the ideal edge profile for each regrinding and the tooth profile obtained when the gear 1 is cut by the machined edge profile for each regrinding. The tooth thickness deviation computing unit 34 computes the deviation between the tooth thickness obtained when the gear 1 is cut by the ideal edge profile for each regrinding and the tooth thickness obtained when the gear 1 is cut by the machined edge profile for each regrinding. The crossed axes angle gradual change amount computing unit 35 computes the gradual change amount of the crossed axes angle η for optimizing the deviation between the tooth profiles for each regrinding. The movement amount gradual change amount computing unit 36 computes the gradual change amount of the movement amount in the translating direction M33 for optimizing the deviation between the tooth thicknesses for each regrinding. The modified machined edge profile computing unit 37 computes the modified machined edge profile of the gear cutter 2 for each regrinding using the grinding wheel 3 based on the gradual change amount of the crossed axes angle η for each regrinding and the gradual change amount of the movement amount in the translating direction M33 for each regrinding. The tool profile determining unit 38 determines the profile of the gear cutter 2 based on the modified machined edge profile for each regrinding.

The tooth profile deviation computing unit 33 computes the modified deviation between the tooth profile obtained when the gear 1 is cut by the ideal edge profile for each regrinding and the tooth profile obtained when the gear 1 is cut by the modified machined edge profile for each regrinding. The tooth thickness deviation computing unit 34 computes the modified deviation between the tooth thickness obtained when the gear 1 is cut by the ideal edge profile for each regrinding and the tooth thickness obtained when the gear 1 is cut by the modified machined edge profile for each regrinding. The crossed axes angle gradual change amount computing unit 35 recomputes the gradual change amount of the crossed axes angle η for each regrinding when the determined modified deviation between the tooth profiles for each regrinding falls out of the predetermined allowable range. The movement amount gradual change amount computing unit 36 recomputes the gradual change amount of the movement amount in the translating direction M33 for each regrinding when the determined modified deviation between the tooth thicknesses for each regrinding falls out of the predetermined allowable range.

The tool profile simulation apparatus 30 of this embodiment repeatedly computes the gradual change amount of the crossed axes angle η and the gradual change amount of the movement amount in the translating direction M33 until the tooth profile deviation and the tooth thickness deviation fall within the predetermined allowable ranges. Thus, it is possible to attain the profile of the skiving gear cutter 2 in which a larger regrinding amount can be secured.

The tool profile simulation method for the gear cutter of this embodiment is a method for determining the profile of the gear cutter 2 having the plurality of cutting teeth 2a on its peripheral face. The gear cutter 2 is a tool to be used for skiving that is performed in a state in which the central axis X2 of the gear cutter 2 is inclined with respect to the central axis X1 of the gear 1 to be cut by the gear cutter 2, and is a tool to be manufactured by causing the grinding wheel 3 formed into a disc profile to grind the edge side faces of the gear cutter 2 by rotating the gear cutter 2 about the central axis X2 of the gear cutter 2, rotating the grinding wheel 3 about the central axis X3 of the grinding wheel 3, relatively moving the grinding wheel 3 in the direction of the central axis X2 of the gear cutter 2, and relatively moving the grinding wheel 3 in the translating direction M33 that is the rotational tangent direction of the gear cutter 2 in a state in which the central axis X2 of the gear cutter 2 and the central axis X3 of the grinding wheel 3 are inclined by the crossed axes angle η from a state in which the central axis X2 of the gear cutter 2 and the central axis X3 of the grinding wheel 3 are orthogonal to each other.

The tool profile simulation method includes the ideal edge profile computing step, the machined edge profile computing step, the tooth profile deviation computing step, the tooth thickness deviation computing step, the crossed axes angle gradual change amount computing step, the movement amount gradual change amount computing step, the modified machined edge profile computing step, and the tool profile determining step. The ideal edge profile computing step is a step of computing the ideal edge profile of the gear cutter 2 for each regrinding. The machined edge profile computing step is a step of computing the machined edge profile of the gear cutter 2 for each regrinding using the grinding wheel 3. The tooth profile deviation computing step is a step of computing the deviation between the tooth profile obtained when the gear 1 is cut by the ideal edge profile for each regrinding and the tooth profile obtained when the gear 1 is cut by the machined edge profile for each regrinding. The tooth thickness deviation computing step is a step of computing the deviation between the tooth thickness obtained when the gear 1 is cut by the ideal edge profile for each regrinding and the tooth thickness obtained when the gear 1 is cut by the machined edge profile for each regrinding. The crossed axes angle gradual change amount computing step is a step of computing the gradual change amount of the crossed axes angle η for optimizing the deviation between the tooth profiles for each regrinding. The movement amount gradual change amount computing step is a step of computing the gradual change amount of the movement amount in the translating direction M33 for optimizing the deviation between the tooth thicknesses for each regrinding. The modified machined edge profile computing step is a step of computing the modified machined edge profile of the gear cutter 2 for each regrinding using the grinding wheel 3 based on the gradual change amount of the crossed axes angle η for each regrinding and the gradual change amount of the movement amount in the translating direction M33 for each regrinding. The tool profile determining step is a step of determining the profile of the gear cutter 2 based on the modified machined edge profile for each regrinding.

The tooth profile deviation computing step includes computing the modified deviation between the tooth profile obtained when the gear 1 is cut by the ideal edge profile for each regrinding and the tooth profile obtained when the gear 1 is cut by the modified machined edge profile for each regrinding. The tooth thickness deviation computing step includes computing the modified deviation between the tooth thickness obtained when the gear 1 is cut by the ideal edge profile for each regrinding and the tooth thickness obtained when the gear 1 is cut by the modified machined edge profile for each regrinding. The crossed axes angle gradual change amount computing step includes recomputing the gradual change amount of the crossed axes angle η for each regrinding when the determined modified deviation between the tooth profiles for each regrinding falls out of the predetermined allowable range. The movement amount gradual change amount computing step includes recomputing the gradual change amount of the movement amount in the translating direction M33 for each regrinding when the determined modified deviation between the tooth thicknesses for each regrinding falls out of the predetermined allowable range. Thus, effects similar to those of the tool profile simulation apparatus 30 can be attained.

What is claimed is:

1. A gear cutter machining apparatus, comprising:
a grinding wheel formed into a disc profile; and
a controller configured to control the grinding wheel to grind edge side faces of a gear cutter having a plurality of cutting teeth on its peripheral face in a state in which a central axis of the gear cutter and a central axis of the grinding wheel are inclined by a crossed axes angle from a state in which the central axis of the gear cutter and the central axis of the grinding wheel are orthogonal to each other, wherein
the gear cutter is a tool to be used for skiving that is performed in a state in which the central axis of the gear cutter is inclined with respect to a central axis of a gear to be cut by the gear cutter, and
the controller includes:
a rotation control unit configured to rotate the gear cutter about the central axis of the gear cutter, and to rotate the grinding wheel about the central axis of the grinding wheel; and
a movement control unit configured to gradually change the crossed axes angle when relatively moving the grinding wheel in a direction of the central axis of the gear cutter, and to move the grinding wheel in a translating direction that is a rotational tangent direction of the gear cutter.

2. The gear cutter machining apparatus according to claim 1, wherein the movement control unit is configured to perform control for gradually increasing a change amount of the crossed axes angle when relatively moving the grinding wheel from one end face toward the other end face of the gear cutter in the direction of the central axis of the gear cutter.

3. The gear cutter machining apparatus according to claim 1, wherein the movement control unit is configured to gradually change a movement amount in the translating direction that is the rotational tangent direction of the gear cutter when moving the grinding wheel in the translating direction.

4. The gear cutter machining apparatus according to claim 3, wherein the movement control unit is configured to perform control for gradually increasing a change amount of the movement amount in the translating direction when relatively moving the grinding wheel from the one end face toward the other end face of the gear cutter in the direction of the central axis of the gear cutter.

5. The gear cutter machining apparatus according to claim 1, wherein the controller includes:
an ideal edge profile computing unit configured to compute an ideal edge profile of the gear cutter for each regrinding;
a machined edge profile computing unit configured to compute a machined edge profile of the gear cutter for each regrinding using the grinding wheel;
a tooth profile deviation computing unit configured to compute a deviation between a tooth profile obtained when the gear is cut by the ideal edge profile for each regrinding and a tooth profile obtained when the gear is cut by the machined edge profile for each regrinding; and
a crossed axes angle gradual change amount computing unit configured to compute a gradual change amount of the crossed axes angle for optimizing the deviation between the tooth profiles for each regrinding.

6. The gear cutter machining apparatus according to claim 3, wherein the controller includes:
an ideal edge profile computing unit configured to compute an ideal edge profile of the gear cutter for each regrinding;
a machined edge profile computing unit configured to compute a machined edge profile of the gear cutter for each regrinding using the grinding wheel;
a tooth profile deviation computing unit configured to compute a deviation between a tooth profile obtained when the gear is cut by the ideal edge profile for each regrinding and a tooth profile obtained when the gear is cut by the machined edge profile for each regrinding;
a tooth thickness deviation computing unit configured to compute a deviation between a tooth thickness obtained when the gear is cut by the ideal edge profile for each regrinding and a tooth thickness obtained when the gear is cut by the machined edge profile for each regrinding;
a crossed axes angle gradual change amount computing unit configured to compute a gradual change amount of the crossed axes angle for optimizing the deviation between the tooth profiles for each regrinding; and
a movement amount gradual change amount computing unit configured to compute a gradual change amount of the movement amount in the translating direction for optimizing the deviation between the tooth thicknesses for each regrinding.

7. A gear cutter machining method that uses a grinding wheel formed into a disc profile, and causes the grinding wheel to grind edge side faces of a gear cutter having a plurality of cutting teeth on its peripheral face in a state in which a central axis of the gear cutter and a central axis of the grinding wheel are inclined by a crossed axes angle from a state in which the central axis of the gear cutter and the central axis of the grinding wheel are orthogonal to each other, wherein
the gear cutter is a tool to be used for skiving that is performed in a state in which the central axis of the gear cutter is inclined with respect to a central axis of a gear to be cut by the gear cutter,
the gear cutter machining method comprising:
a rotation control step of rotating the gear cutter about the central axis of the gear cutter, and rotating the grinding wheel about the central axis of the grinding wheel; and
a movement control step of gradually changing the crossed axes angle when relatively moving the grinding wheel in a direction of the central axis of the gear cutter, and moving the grinding wheel in a translating direction that is a rotational tangent direction of the gear cutter.

8. The gear cutter machining method according to claim 7, wherein the movement control step includes gradually changing a movement amount in the translating direction that is the rotational tangent direction of the gear cutter when moving the grinding wheel in the translating direction.

9. A simulation apparatus configured to determine a profile of a gear cutter having a plurality of cutting teeth on its peripheral face, wherein
the gear cutter is a tool to be used for skiving that is performed in a state in which a central axis of the gear cutter is inclined with respect to a central axis of a gear to be cut by the gear cutter, and is a tool to be manufactured by causing a grinding wheel formed into a disc profile to grind edge side faces of the gear cutter by rotating the gear cutter about the central axis of the gear cutter, rotating the grinding wheel about a central axis of the grinding wheel, relatively moving the grinding wheel in a direction of the central axis of the gear cutter, and relatively moving the grinding wheel in a translating direction that is a rotational tangent direction of the gear cutter in a state in which the central axis of the gear cutter and the central axis of the grinding wheel are inclined by a crossed axes angle from a state in which the central axis of the gear cutter and the central axis of the grinding wheel are orthogonal to each other,
the simulation apparatus comprising:
an ideal edge profile computing unit configured to compute an ideal edge profile of the gear cutter for each regrinding;
a machined edge profile computing unit configured to compute a machined edge profile of the gear cutter for each regrinding using the grinding wheel;
a tooth profile deviation computing unit configured to compute a deviation between a tooth profile obtained when the gear is cut by the ideal edge profile for each regrinding and a tooth profile obtained when the gear is cut by the machined edge profile for each regrinding;
a tooth thickness deviation computing unit configured to compute a deviation between a tooth thickness obtained when the gear is cut by the ideal edge profile for each regrinding and a tooth thickness obtained when the gear is cut by the machined edge profile for each regrinding;
a crossed axes angle gradual change amount computing unit configured to compute a gradual change amount of the crossed axes angle for optimizing the deviation between the tooth profiles for each regrinding;
a movement amount gradual change amount computing unit configured to compute a gradual change amount of a movement amount in the translating direction for optimizing the deviation between the tooth thicknesses for each regrinding;
a modified machined edge profile computing unit configured to compute a modified machined edge profile of the gear cutter for each regrinding using the grinding wheel based on the gradual change amount of the crossed axes angle for each regrinding and the gradual change amount of the movement amount in the translating direction for each regrinding; and
a tool profile determining unit configured to determine the profile of the gear cutter based on the modified machined edge profile for each regrinding, wherein
the tooth profile deviation computing unit is configured to compute a modified deviation between the tooth profile obtained when the gear is cut by the ideal edge profile for each regrinding and a tooth profile obtained when the gear is cut by the modified machined edge profile for each regrinding,
the tooth thickness deviation computing unit is configured to compute a modified deviation between the tooth thickness obtained when the gear is cut by the ideal edge profile for each regrinding and a tooth thickness obtained when the gear is cut by the modified machined edge profile for each regrinding,
the crossed axes angle gradual change amount computing unit is configured to recompute the gradual change amount of the crossed axes angle for each regrinding when the determined modified deviation between the tooth profiles for each regrinding falls out of a predetermined allowable range, and
the movement amount gradual change amount computing unit is configured to recompute the gradual change amount of the movement amount in the translating direction for each regrinding when the determined modified deviation between the tooth thicknesses for each regrinding falls out of a predetermined allowable range.

10. A simulation method for determining a profile of a gear cutter having a plurality of cutting teeth on its peripheral face, wherein
the gear cutter is a tool to be used for skiving that is performed in a state in which a central axis of the gear cutter is inclined with respect to a central axis of a gear to be cut by the gear cutter, and is a tool to be manufactured by causing a grinding wheel formed into a disc profile to grind edge side faces of the gear cutter by rotating the gear cutter about the central axis of the gear cutter, rotating the grinding wheel about a central axis of the grinding wheel, relatively moving the grinding wheel in a direction of the central axis of the gear cutter, and relatively moving the grinding wheel in a translating direction that is a rotational tangent direction of the gear cutter in a state in which the central axis of the gear cutter and the central axis of the grinding wheel are inclined by a crossed axes angle from a state in which the central axis of the gear cutter and the central axis of the grinding wheel are orthogonal to each other,
the simulation method comprising:
an ideal edge profile computing step of computing an ideal edge profile of the gear cutter for each regrinding;
a machined edge profile computing step of computing a machined edge profile of the gear cutter for each regrinding using the grinding wheel;
a tooth profile deviation computing step of computing a deviation between a tooth profile obtained when the gear is cut by the ideal edge profile for each regrinding and a tooth profile obtained when the gear is cut by the machined edge profile for each regrinding;
a tooth thickness deviation computing step of computing a deviation between a tooth thickness obtained when the gear is cut by the ideal edge profile for each regrinding and a tooth thickness obtained when the gear is cut by the machined edge profile for each regrinding;
a crossed axes angle gradual change amount computing step of computing a gradual change amount of the crossed axes angle for optimizing the deviation between the tooth profiles for each regrinding;
a movement amount gradual change amount computing step of computing a gradual change amount of a movement amount in the translating direction for optimizing the deviation between the tooth thicknesses for each regrinding;
a modified machined edge profile computing step of computing a modified machined edge profile of the gear cutter for each regrinding using the grinding wheel based on the gradual change amount of the crossed axes angle for each regrinding and the gradual change amount of the movement amount in the translating direction for each regrinding; and
a tool profile determining step of determining the profile of the gear cutter based on the modified machined edge profile for each regrinding, wherein
the tooth profile deviation computing step includes computing a modified deviation between the tooth profile obtained when the gear is cut by the ideal edge profile for each regrinding and a tooth profile obtained when the gear is cut by the modified machined edge profile for each regrinding,
the tooth thickness deviation computing step includes computing a modified deviation between the tooth thickness obtained when the gear is cut by the ideal edge profile for each regrinding and a tooth thickness obtained when the gear is cut by the modified machined edge profile for each regrinding,
the crossed axes angle gradual change amount computing step includes recomputing the gradual change amount of the crossed axes angle for each regrinding when the determined modified deviation between the tooth profiles for each regrinding falls out of a predetermined allowable range, and
the movement amount gradual change amount computing step includes recomputing the gradual change amount of the movement amount in the translating direction for each regrinding when the determined modified deviation between the tooth thicknesses for each regrinding falls out of a predetermined allowable range.
